(19) United States
(12) Patent Application Publication
(10) Pub. No.: US 2004/0137210 A1
(43) Pub. Date: Jul. 15, 2004

(54) Composite pad

(75) Inventors: Randy Ochoa, Richardson, TX (US); Larry West, Trophy Club, TX (US); Natarajan S. Ramesh, Grapevine, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 10/341,992

(22) Filed: Jan. 14, 2003

(51) Int. Cl. B32B 3/26; B32B 3/00; B32B 9/00

(52) U.S. Cl. 428/315.9; 428/304.4; 428/318.4

(57) ABSTRACT

The invention is a composite pad that is particularly useful in a horse trailer, exercise room, playroom, or the like. The pad has a moisture impermeable and scuff resistant outer skin layer, a cushioning layer, an impact absorbing layer, and a backing layer.

### BACKGROUND OF THE INVENTION

This invention relates to protective pads, and in particular to pads that are useful in horse and livestock trailers.

Horses are often transported in trailers towed behind motorized vehicles. Typically, horse trailers have steel or aluminum frames that are exposed within the animal compartments. The trailer's outer surface is usually either aluminum or steel siding that is attached to the frame.

While in transport, the animal usually remains standing and is subject to directional forces exerted on the trailer. As a result, the horse may frequently shift position and bump into the trailer's sidewalls. To protect both the animal and trailer, it is necessary to cover the frame and siding with a protective lining. The lining must offer protection from the animal's shifting weight and have barrier properties to resist the absorption of moisture, urine, or horse manure.

Protective pads used to line a horse trailer's interior typically have a foam core, a cardboard back, and a vinyl outer surface that wraps around the core and back. Normally, the vinyl outer surface is attached to the backside of the cardboard leaving a portion of the cardboard back uncovered. The pads are attached to the trailer with their cardboard backs against the sidewall and their vinyl outer surfaces facing the trailer's interior compartment. This design has many significant drawbacks.

The vinyl surface does not stand up to abuse and requires frequent replacement of the pad. Often, the animal will chew or bite the vinyl surface, which may result in the animal actually ingesting the material. Additionally, the vinyl surface is easily cracked, torn, and bruised by the animal's frequent shifting or kicking. Openings created in the vinyl surface facilitate moisture ingress into the pad's core and cardboard back.

The cardboard back provides insufficient barrier protection and readily absorbs moisture, manure, and urine. When moisture enters into the pad or comes in contact with the cardboard, the cardboard back normally does not maintain its structural integrity, resulting in the protective pad providing insufficient protection to both trailer and horse. Moisture ingress into the pad becomes a breeding ground for bacterial and fungi growth. This results in an environment that is both unpleasant and unhealthy for the animal. Since the pad is easily damaged by moisture it cannot be readily washed or cleaned and must be replaced frequently.

A need exists to provide a pad that is abrasion and tear resistant, provides adequate cushioning, and offers superior barrier protection.

### BRIEF SUMMARY OF THE INVENTION

The invention is a composite pad that is particularly suited for use in a livestock or horse trailer. The pad's design is a sharp change from currently existing pads and it is expected that the pad's useful lifespan will greatly exceed that of other pads. The outer protective surface of the pad is a skin layer. The skin layer's inner surface is attached to a cushioning layer, such as polyethylene foam. For structural support the pad has a backing layer that is a semi-rigid liquid impervious material, such as a corrugated plastic. An impact absorbing layer is sandwiched between the cushioning and backing layers. The cushioning layer has a cushioning effect that improves the structural integrity of the skin. Load distributing properties of the cushioning layer protect the impact absorbing layer from tearing. The skin and cushioning layer combination extend beyond the periphery of the backing layer and are folded around the backing layer and attached to a surface on the backing layer that is opposite the impact absorbing layer. Thus, the invention provides a composite pad in which the exterior of the pad is sealed to prevent moisture ingress into the pad's interior, and thereby greatly increases the pad's utility and lifespan.

The skin layer is normally made from ionomer, nylon, low-density polyethylene, high-density polyethylene, or polyester. The skin layer can be embossed to provide superior resistance to scuffing and dulling. The skin layer is at least about 2 mils thick and is typically from about 5 to 50 mils thick, and somewhat more typically from about 10 to 40 mils thick, and even more typically from about 20 to 35 mils thick.

The backing layer is a semi-rigid liquid impervious material that supports and maintains the pad's structural integrity. The backing layer is typically a corrugated plastic made from polyolefins, including polyethylene (high-density and low-density), polypropylene, polystyrene, polyethylene terephthalate, acrylonitrile butadiene styrene, polyesters, polyurethane, and phenolics. A useful thickness for the backing layer is from about ⅛ to 2 inches thick, and somewhat more useful, is a thickness from about ⅛ to 1/4 inch thick. The impact absorbing layer can cover the entire top surface of the backing layer, or, alternatively, a portion of the top surface that is about 1 to 2 inches wide and extends around the entire perimeter of the backing layer may remain uncovered by the impact absorbing layer.

The cushioning layer is typically a polyolefin such as polyethylene. The cushioning layer is less than about 4 inches thick. Thicknesses less than 1 inch, and especially less than ½ inch are somewhat more typical. The cushioning layer has a density that is from about 1 to 9 pounds per cubic foot (“pcf”), and somewhat more useful, is a density that is from about 4 to 8 pcf.

The impact absorbing layer is usually a low-density foam that has good impact absorption properties. Low-density foams that are useful as the impact absorbing layer include polyolefins, such as low-density polyethylene foam. Typically, the impact absorbing layer is less than about 4 inches thick, and somewhat more typical is a thickness that is from about 1 to 3 inches. The foam may have a density from about 1 to 9 pcf. Densities from about 1.2 to 4 pcf, and especially about 1.7 pcf, are somewhat more typical.

The pad may also have an antimicrobial agent to help prevent the growth and reproduction of microorganisms. The antimicrobial agent can be topically applied to the pad, or the agent can be applied during polymer formation so that the antimicrobial agent is incorporated into polymeric structures of the pad's individual components. The pad may also have other additives such as UV/light stabilizers and antioxidants.

Thus, a composite pad is provided by the invention that is useful for cushioning in moist and wet environments and can be secured or fastened to a surface or wall. The pad is useful as a protective lining for the interior of a horse trailer. The bottom surface of the backing layer is secured to a wall within the trailer and the skin layer faces outward towards the animal compartment. The pad can come in a variety of different shapes and sizes.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an environmental perspective of a horse trailer having the composite pads of the invention;

FIG. 2 is an interior view of the horse trailer depicted in FIG. 1;

FIG. 3 is a perspective view of a composite pad that is in accordance with the invention;

FIG. 4 is a side cross-sectional view of a composite pad that is in accordance with the invention;

FIG. 5 is a side cross-sectional view of a second embodiment of the composite pad depicted in FIG. 3;

FIG. 6 is a side cross-sectional view of a third embodiment of the composite pad depicted in FIG. 3;

FIG. 7 is an aerial view depicting the back-side of a composite pad that is in accordance with the invention;

FIG. 8A is a perspective view of a composite pad that is in accordance with the invention;

FIG. 8B is a perspective view of a composite pad that is in accordance with the invention;

FIG. 8C is a perspective view of a composite pad that is in accordance with the invention.

### DETAILED DESCRIPTION OF THE INVENTION

The invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

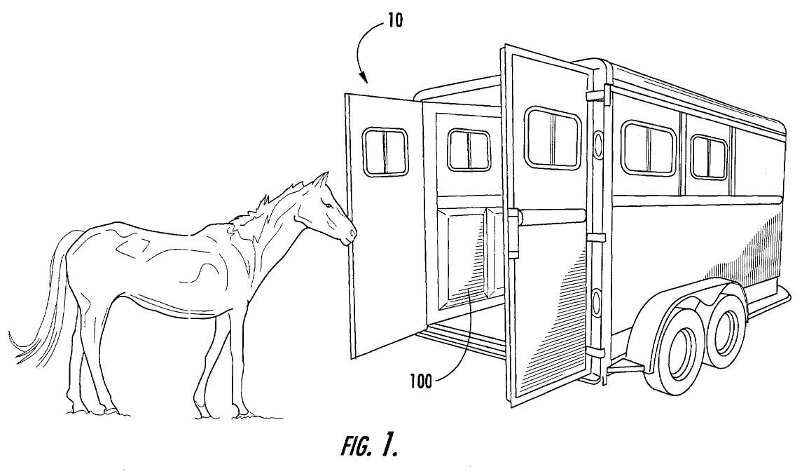

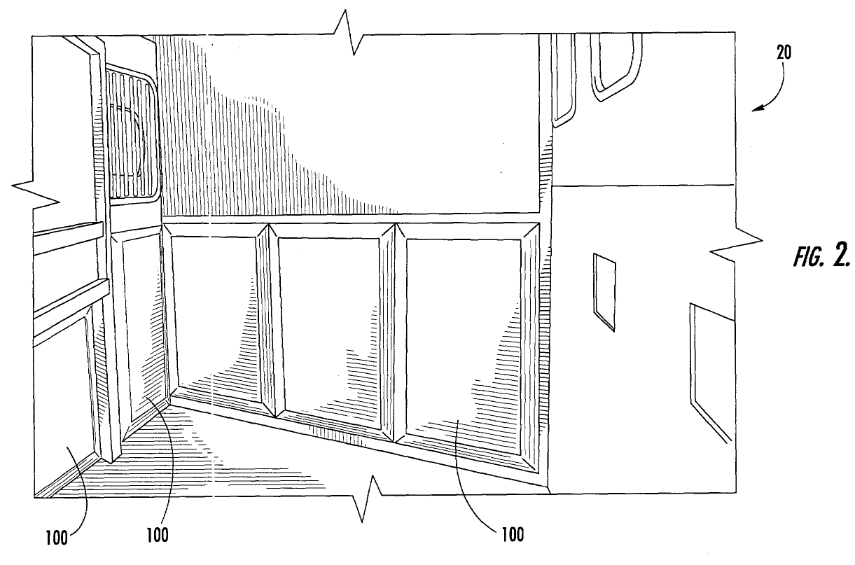

Referring more specifically to the drawings, for purposes of illustration, but not of limitation, there is shown in FIG. 1 a horse trailer 10 embodying the features of the invention. As shown, horse trailer 10 has protective pads 100 mounted to the trailer's sidewalls. With reference to FIG. 2, the interior of a horse trailer is broadly designated by reference number 20. As illustrated in FIG. 2, the inside sidewalls are covered with protective pads 100 embodying the features of the invention.

With reference to FIG. 4, a cross-sectional view of the protective pad 100 embodying the features of the invention is illustrated. The protective pad 100 comprises four layers: a skin layer 110; a cushioning layer 120; an impact absorbing layer 130; and a backing layer 140. The skin layer 110 covers the pad's exposed outer surface. Attached to the skin layer's inner surface is a cushioning layer 120. The skin 110 and cushioning layers 120 comprise the pad's outer abuse layer 114. Normally, the abuse layer 114 wraps around the backing layer and is secured to its bottom surface 142 at 144. In this regard, FIG. 7 illustrates the combination 114 of the skin layer 110 and the cushioning layer 120 attached to the backside of the pad. The impact absorbing layer 130 is sandwiched between the backing layer and the cushioning layer, and is attached on one side to the backing layer's top surface 146 and on the other, to the cushioning layer's lower surface 122.

The skin layer is the protective pad's outer abuse surface. The skin layer should be able to withstand harsh abuse that would normally be encountered in environments such as a horse trailer. Desirable characteristics of the skin layer include moisture and urine resistance, abrasion and scuff resistance, chemical resistance, and low temperature impact toughness. Typically, the skin layer is a film made out of ionomer, nylon, low-density polyethylene, high-density polyethylene, polypropylene, or other polymeric materials that are moisture resistant and able to withstand abuse. Surlyn,® an ionomer available from E. I. Du Pont de Nemours and Co., has many of the desired characteristics, making it a suitable choice for the skin layer. However, the skin layer is not limited to the above recited materials, and other materials may be substituted so long as the skin layer provides superior barrier protection and can withstand abuse.

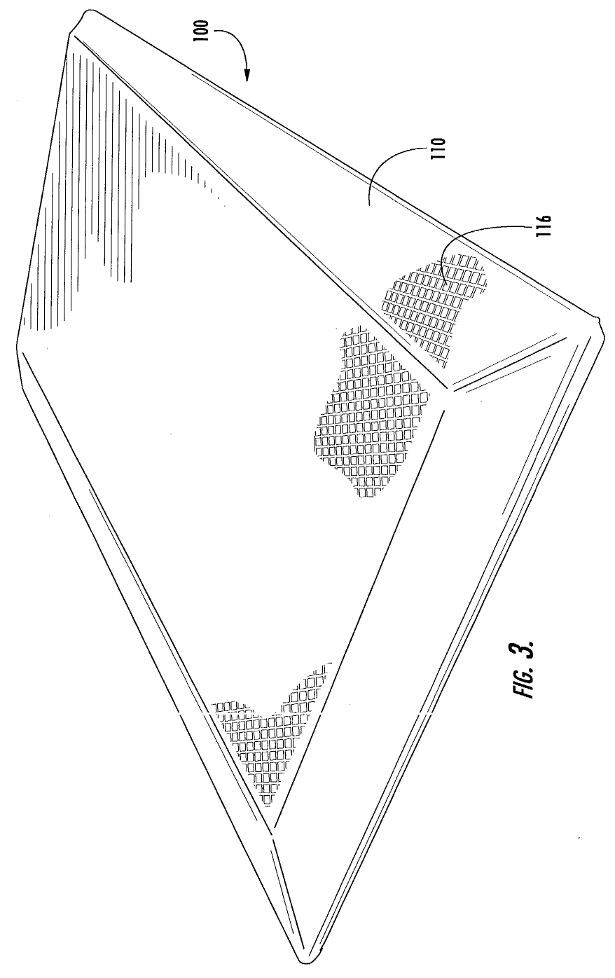

Optionally, the outer surface 112 is embossed as illustrated in FIG. 3 at 116. As shown in FIG. 3, the outer surface is embossed in a diamond pattern. The skin layer can be embossed in any conventional manner with any desired pattern. Embossing the outer surface helps to prevent scuffing that results from frequent rubbing of the surface. The skin layer is at least about 2 mils thick, and a typical thickness range is from about 5 to 50 mils. Thicknesses from about 10 to 40 mils, and especially from about 20 to 35 mils are somewhat more typical.

The data in Table 1 is representative of the significant advantages that are obtained with an abrasion resistant skin layer secured to a cushioning layer. The wear index of each of the following samples was obtained by using ASTM Method D-4060-01. Wear index is a measure of a material's abrasion resistance and is calculated with the following equation:

I=((A−B)1000)/C

where A=weight of test specimen before abrasion, mg;

B=weight of test specimen after abrasion, mg; and

C=number of cycles of abrasion recorded.

To determine wear index the sample material was mounted on an Abraser Model 5130 turntable and Calibrase H-18 abrasive wheels were lowered into contact with the sample material. The wheels were loaded with a 1000 g weight and then the sample was subject to 100 cycles on the turntable. Typically, a lower wear index provides better scuff and abrasion resistance.

TABLE 1

| | | Initial | Final | Percent | | |
|---|---|---|---|---|---|---|
| | | weight | Weight | Loss of | Wear | Surface |
| Sample | materials | (g) | (g) | Wear | Index | Appearance |
| 1 | PVC | 5.137 | 5.096 | .8 | 0.41 | Torn and |
| | | | | | | surface |
| | | | | | | damaged/ |
| | | | | | | pinholes |
| 2 | 6 pcf 1/8″ | 10.682 | 10.667 | .14 | 0.15 | Slight wear |
| | LDPE foam | | | | | |
| 3 | 6 pcf 1/8″ | 10.577 | 10.565 | .11 | 0.12 | Negligible |
| | HDPE foam/ | | | | | wear, no |
| | 20 mil LDPE | | | | | surface |
| | skin* | | | | | defects |
| 4 | Rubber mat | 54.229 | 54.110 | .22 | 1.19 | Slight wear |

*diamond embossed skin

As is evident from the data in Table 1, sample 3 has superior scuff and wear resistance than the other samples tested. Sample 3, which is in accordance with the invention, is comprised of a thin low-density polyethylene skin having a thickness about 20 mils secured to a high-density polyethylene foam having a thickness about 1/8 inch thick and density about 6 pcf. Sample 1, which consists of polyvinyl chloride, had noticeable wear and a percent loss of material that was approximately 7 times that of sample 3. Samples 2 and 4 consisting of 1/8 inch low-density polyethylene foam and a rubber mat, respectively, both showed slight wear.

As shown in FIGS, 4, 5, and 6, the cushioning layer 120 is attached to the skin layer. The cushioning layer provides a cushioning effect so that the skin layer can be shaped without cracking and is not easily torn or damaged from a horse's kicking or biting. The cushioning layer also tends to distribute impact forces over its surface so as to protect the underlying lower density impact absorbing layer which otherwise would tear more easily.

Typically, high-density foam, such as a polyolefin, is selected as the material for the cushioning layer. Useful polyethylene resins include polyethylene homopolymers and copolymers. Useful polyethylene homopolymers include low-density polyethylene (LDPE), linear low-density polyethylene (LLDPE), and high-density polyethylene (HDPE). Polyethylene copolymers may include homogeneous ethylene/alpha-olefin copolymers, such as matallocene/single-site catalyzed copolymers of ethylene and one or more C₃ to C₁₀ alpha-olefin comonomers, or heterogeneous Ziegler-Natta catalyzed ethylene/alpha-olefin copolymers. Other ethylene copolymers include propylene, higher olefins and carboxylic acids and esters. Various ethylene copolymers are used in which the second comonomer is a carboxylic acid or ester such as vinyl acetate, acrylic acid, methacrylic acid, methacrylate and ethyl acrylate. Ethylene vinyl acetate (EVA) copolymers with vinyl acetate content ranging up to 30% weight could be used copolymers, such as homogeneous ethylene/alpha-olefin copolymers, heterogeneous Ziegler-Natta catalyzed ethylene/alpha-olefin copolymers, and ethylene vinyl acetate (EVA) copolymers.

It is desirable that the cushioning layer 120 is about 1/8 inch thick or less. Thicknesses less than 1/2inch, 1 inch, or 4 inches are also useful, although not necessarily with equivalent results. The cushioning layer has a density from about 1 to 9 pcf, and somewhat more typical, is a density from about 4 to 8 pcf.

The abuse layer 114 can also be formed from a commercially available laminate that is commonly known as “slick skin.” Typically, slick skin has a scuff resistant outer film and high-density foam attached to the skin's inner surface.

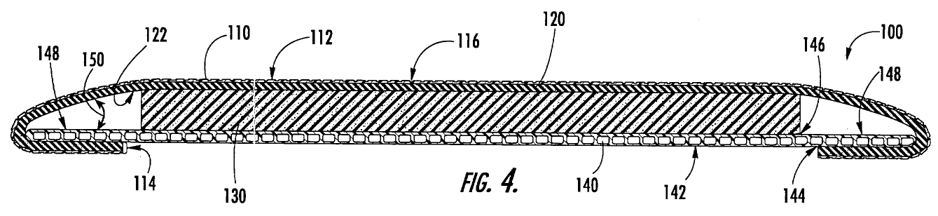

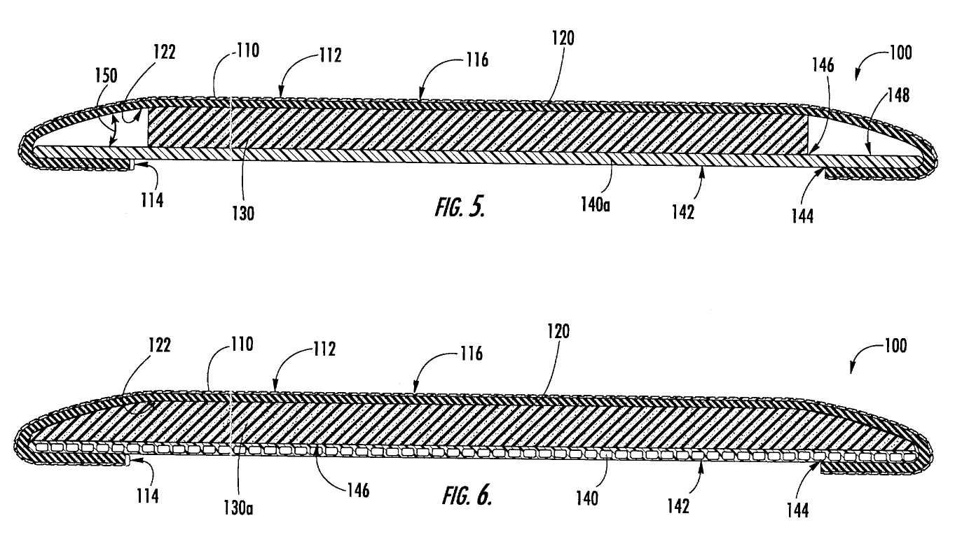

As shown in FIGS. 4, 5, and 6 the impact absorbing layer 130 is attached to the cushioning layer's lower surface 122 and to the backing layer's top surface 146. Normally, the impact absorbing layer 130 does not extend over the entire top surface 146, as shown in FIGS. 4 and 5 at 148. The uncovered area 148 extends around the entire outer perimeter of the top surface. However the impact absorbing layer may cover substantially the entire top surface 146. In this regard, FIG. 6 shows the impact absorbing layer 130a extending to the edges of the backing layer. In this embodiment, the portion of the impact absorbing layer that extends to the edge of the backing layer is cut at an angle. Depending upon thickness, the impact absorbing layer is cut to approximate the angle degree that results between the cushioning layer and the backing layer, as shown at 150 (FIG. 5). The angled cut allows the impact absorbing layer to be closely fitted between the backing layer 140 and abuse layer 114 and helps to prevent the impact absorbing layer 130 from sagging.

The impact absorbing layer 130 supplies the pad's impact absorption effect. The layer 130 is normally made from low-density foam that provides high-resiliency, good shock absorption, and moisture barrier protection. The impact absorbing layer can be made from foamed thermosetting or thermoplastic polymers and copolymers. Typical materials include, without limitation, polyolefins such as polyethylene, polypropylene, polybutene, polystyrene, and other polymeric materials that provide impact absorption. Typically, the above-cited resins that are useful for the cushioning layer are also useful for the impact absorbing layer. An ideal choice for the impact absorbing layer is Stratocell® polyethylene foam available from Sealed Air Corp. of Saddle Brook, N.J. The impact absorbing layer may be a homogeneous or a heterogeneous foam, or a laminate comprised of foam layers having various thicknesses and densities. The impact absorbing layer is not limited to the above recited materials and other materials may be substituted so long as they are moisture resistant and possess good shock absorption, although not necessarily with equivalent results. Typically, the impact absorbing layer is from about ½ to 4 inches thick. Thicknesses from about ¾ to 3.5 inches, and especially from about 1 to 3 inches are somewhat more typical. The layer's density is from about 1 to 9 pcf, and, somewhat more useful is a density from about 1.2 to 4 pcf, and even more useful, is a density about 1.7 pcf.

The backing layer 140 provides the pad's structural support. Normally, as illustrated in FIGS. 4 and 6, the backing layer is a corrugated material, which minimizes the pad's overall weight. However, the backing layer is not necessarily corrugated, and as shown in FIG. 5, the backing layer 140a can be a substantially solid material. The backing layer is made of a material that prevents moisture ingress into the pad's interior and should be stiff enough to ensure adequate support for the pad, but not so stiff as to be brittle. Typically, the backing layer is made from materials that include, without limitation, polyolefins, including polyethylene (high-density and low-density), polypropylene, polystyrene, polyethylene terephthalate, acrylonitrile butadiene styrene, polyesters, polyurethane, phenolics, reinforced plastics, and other polymeric materials that are semi-rigid and have a high strength to weight ratio. The backing layer is typically from about ⅛ to 2 inches thick, with thickness from about ⅛ to ½ or ⅛ to 1/4 inch thick being the more usual case.

With reference to FIG. 7, the skin 110 and cushioning layer are shown attached to the backing layer's bottom surface 142. As shown, the corners of the skin and cushioning layer are cut so that the layers 110, 120 are easily attached and lie flush to the bottom surface 142. Adhesive is applied along all exposed edges 144 so that the pad is completely sealed to prevent moisture ingress into the pad's interior. Normally, an adhesive is used to attach the pad's layers to each other. Other methods of attachment include heat lamination and UV sealing, although not necessarily with equivalent results.

The skin layer 110, foam layers 120, 130, and backing layer 140 may also contain antimicrobial or antifungal additives in any or all of these layers. Antimicrobial and antifungal additives neutralize the ability of bacteria and other microorganisms to grow, function, or reproduce. Normally, the antimicrobial agent is mixed with the polymer base resin during the formation of the film or foam. Alternatively, the pad is rendered antimicrobial by topically treating the skin layer with the antimicrobial agent.

The anitimicrobial agent is practically insoluble in water, and is safe, non-toxic, non-carcinogenic, and non-sensitizing to animals and humans. For example, antimicrobial agents such as 2,4,4′-trichloro-2′hydroxy diphenol ether, or 5-chloro-2-phenol (2,4 dichlorophenoxy) are commonly sold under the trademark Microban, by Microban Products Co. of Huntsville, N.C. Microban is incorporated into the structure of the polymer during formation and can last for the lifetime of the pad. Other useful antimicrobial agents include, without limitation, 10,10′-oxy-bis-phenoxarsin, N-(trihalogenomethylthio)-phthalimide, diphenylstibine-2-ethylhexanoate, copper-bis-(8-hydroxyquinoline), tributyltin oxide and its derivatives, and tri-n-butylin meleate. It is understood that the antimicrobial agent is not limited to those recited above, and other antimicrobial agents may be used. The pad's layers, all or individually, may also contain one or more additives including fillers, antioxidants, flame retardants, UV stabilizers, elastomeric components such as polyisobutylene, polybutadiene, and ethylene-propylene rubber, cross-linking agents, extrusion aids, colorants, pigments, antistatic agents, biostabilizers, and permeability modifiers such as esters and amides of fatty acids, pigments, dyes, plasticizers, or the like.

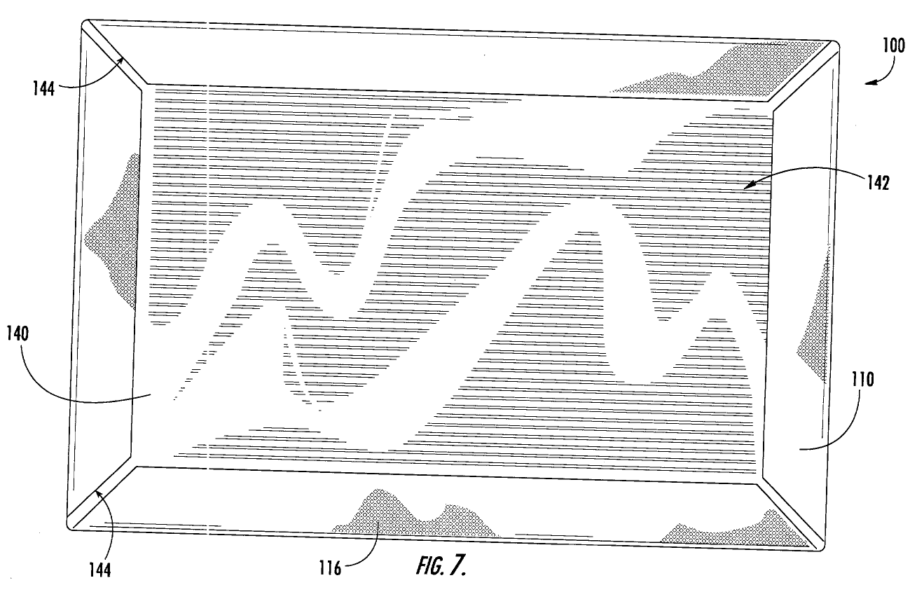

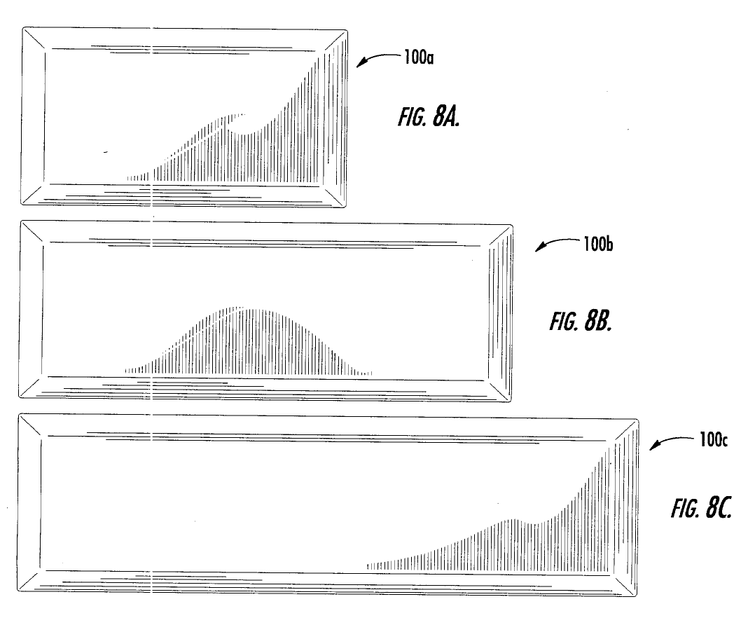

With reference to FIGS. 8A, 8B and 8C, protective pads in accordance with the invention are illustrated. As shown, the pads can come in a variety of different shapes and sizes. Pads of the invention can have angular cuts and be designed for specific applications. Typically, for horse trailer applications, the pads will vary in length from about 80 to 95 inches and in width from about 36 to 48 inches.

The pad's angled edge allows the pad to be easily snapped into place under a drip rail mounted within the horse trailer. In this regard, FIG. 5 at 148 shows an area on the surface of the backing layer that is devoid of foam. At this area 148, the abuse layer and the backing layer are easily compressed together so that the pad will fit between the sidewall and the drip rail. The pads can also be secured to a wall or surface in any other known and conventional manner, including without limitation, adhesives, Velcro, self-tightening screws, nails, rivets, brackets mounted on the pad or trailer wall, and the like.

With reference to FIGS. 1 and 2 a trailer embodying the protective pads is illustrated. As is evident from the foregoing discussion, composite pads constructed in accordance with the invention are particularly suited for use in livestock and horse trailers. The synthetic structure greatly enhances the pad's expected life and durability. In contrast to previous pads, pads in accordance with the invention are easily washed and the skin layer provides a surface that is scuff resistant and withstands abuse. Incorporation of an antimicrobial agent helps to prevent the growth and reproduction of bacteria and other organisms. In addition to having a greater durability and lifespan than currently existing pads, the composite pads are comprised of lightweight synthetic materials and will provide superior insulation and sound dampening characteristics.

It is expected that the pads will be useful in a broad range of applications that far exceeds their use in horse trailers. For instance, the pads would be very useful in a child's playroom where durability, cushioning, and sound dampening are a must. Additionally, the pads could be utilized in an athletic gym as a cushion for a weight lifting bench.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composite cushioning pad comprising:
an abuse layer having a skin layer and a cushioning layer attached thereto;
an impact absorbing layer located so that the cushioning layer is sandwiched between the skin and the impact absorbing layer; and
a semi-rigid backing layer to which said impact absorbing layer is secured opposite said abuse layer.

2. A pad according to claim 1, wherein the abuse layer wraps around the backing layer and is secured to a surface on the backing layer that is opposite the impact absorbing layer.

3. A pad according to claim 1, wherein said backing layer is a corrugated material selected from the groups consisting of polyolefins, including polyethylene, polypropylene, polystyrene, polyethylene terephthalate, acrylonitrile butadiene styrene, polyesters, polyurethane, and phenolics.

4. A pad according to claim 1, wherein said backing layer is from about ⅛ to 2 inches thick.

5. A pad according to claim 1, wherein said backing layer is from about ⅛ to 1/4 inch thick.

6. A pad according to claim 1, wherein said impact absorbing layer is low-density foam.

7. A pad according to claim 6, wherein said impact absorbing layer is a polyolefin.

8. A pad according to claim 1, wherein said impact absorbing layer is comprised of a resin selected from the group consisting of low-density polyethylene (LDPE); linear low-density polyethylene (LLDPE); high-density polyethylene (HDPE); ethylene vinyl acetate (EVA); metallocene/single-site catalyzed copolymers of ethylene and one or more C₃ to C₁₀ alpha-olefin comonomers; heterogeneous Ziegler-Natta catalyzed ethylene/alpha-olefin copolymers; ethylene copolymers of propylene, higher olefins, carboxylic acids, or esters, and combinations thereof.

9. A pad according to claim 1, wherein said impact absorbing layer has a thickness about 4 inches or less.

10. A pad according to claim 1, wherein said impact absorbing layer is from about 1 to 3 inches thick.

11. A pad according to claim 1, wherein said impact absorbing layer has a density from about 1 to 9 pcf.

12. A pad according to claim 1, wherein said impact absorbing layer has a density from about 1.2 to 4 pcf.

13. A pad according to claim 1, wherein said impact absorbing layer has a density about 1.7 pcf.

14. A pad according to claim 1, wherein said cushioning layer is a polyolefin.

15. A pad according to claim 1, wherein said cushioning layer is comprised of a resin selected from the group consisting of low-density polyethylene (LDPE); linear low-density polyethylene (LLDPE); high-density polyethylene (HDPE); ethylene vinyl acetate (EVA); metallocene/single-site catalyzed copolymers of ethylene and one or more C₃ to C₁₀ alpha-olefin comonomers; heterogeneous Ziegler-Natta catalyzed ethylene/alpha-olefin copolymers; ethylene copolymers of propylene, higher olefins, carboxylic acids, or esters, and combinations thereof.

16. A pad according to claim 1, wherein said cushioning layer has a thickness about 4 inches or less.

17. A pad according to claim 1, wherein said cushioning layer is about 1/2 inch thick or less.

18. A pad according to claim 1, wherein said cushioning layer has a density from about 1 to 9 pcf.

19. A pad according to claim 1, wherein said cushioning layer has a density that is from about 4 to 8 pcf.

20. A pad according to claim 1, wherein the skin layer is selected from the groups consisting of ionomer, nylon, polyethylene, and polypropylene.

21. A pad according to claim 20, wherein said skin layer is an ionomer.

22. A pad according to claim 1, wherein said skin layer is at least about 2 mils thick.

23. A pad according to claim 1, wherein said skin layer is from about 5 to 50 mils thick.

24. A pad according to claim 1, wherein said skin layer is from about 15 to 35 mils thick.

25. A pad according to claim 1, wherein said skin layer further comprises an inner and outer surface, wherein said inner surface is attached to said cushioning layer, and said outer surface is embossed.

26. A pad according to claim 1, further comprising an antimicrobial agent.

27. A pad according to claim 26, wherein said antimicrobial agent is selected from the group consisting of 4,4′-trichloro-2′hydroxy diphenol ether, 5-chloro-2-phenol (2,4 dichlorophenoxy), 10,10′-oxy-bis-phenoxarsin, N-(trihalogenomethylthio)-phthalimide, diphenylstibine-2-ethylhexanoate, copper-bis-(8-hydroxyquinoline), tributyltin oxide and its derivatives, and tri-n-butylin meleate.

28. A pad according to claim 1, further comprising an additive selected from the group consisting of aging modifiers, nucleating agents, elastomeric components, UV/light stabilizers, cross-linking agents, extrusion aids, antioxidants, colorants, pigments, permeability modifiers, antistatic agents, biostabilizers, flame retardants, and combinations thereof.

29. A pad according to claim 1, wherein the skin layer is secured to the cushioning layer with an adhesive, heat laminating, or UV sealing.

30. A pad according to claim 1, wherein the impact absorbing layer is secured to the cushioning layer with an adhesive, heat laminating, or UV sealing.

31. A pad according to claim 1, wherein the impact absorbing layer is secured to the backing layer with an adhesive, heat laminating, or UV sealing.

32. A composite pad comprising:
a skin layer having an outer surface and an inner surface;
a high density foam layer attached to said inner surface, said high density layer having a density that is from about 4 to 9 pcf;
a backing layer; and
an impact absorbing layer sandwiched between said high density foam layer and backing layer.

33. A pad according to claim 32, wherein the skin and high density layer extend beyond the periphery of the backing layer and are folded around the backing layer and are attached to a surface on the backing layer that is opposite the impact absorbing layer.

34. A pad according to claim 32, further comprising an antimicrobial agent.

35. A pad according to claim 34, wherein said antimicrobial agent is selected from the group consisting of 4,4′-trichloro-2′hydroxy diphenol ether, 5-chloro-2-phenol (2,4 dichlorophenoxy), 10,10′-oxy-bis-phenoxarsin, N-(trihalogenomethylthio)-phthalimide, diphenylstibine-2-ethylhexanoate, copper-bis-(8-hydroxyquinoline), tributyltin oxide and its derivatives, and tri-n-butylin meleate.

36. A pad according to claim 32, wherein said skin layer is made from polymer selected from the group consisting of ionomer, nylon, low density polyethylene, high density polyethylene, and polyester.

37. A pad according to claim 32, wherein said skin layer is made from polyethylene.

38. A pad according to claim 32, wherein said skin layer has a thickness of at least about 2 mils.

39. A pad according to claim 32, wherein said skin layer possesses a thickness of from about 5 to 50 mils.

40. A pad according to claim 32, wherein said skin layer possesses a thickness of from about 15 to 35 mils.

41. A pad according to claim 32, wherein said skin layer is embossed.

42. A pad according to claim 32, wherein said impact absorbing layer is low-density foam.

43. A pad according to claim 32, wherein said impact absorbing layer is comprised of a resin selected from the group consisting of low-density polyethylene (LDPE); linear low-density polyethylene (LLDPE); high-density polyethylene (HDPE); ethylene vinyl acetate (EVA); metallocene/single-site catalyzed copolymers of ethylene and one or more C₃ to C₁₀ alpha-olefin comonomers; heterogeneous Ziegler-Natta catalyzed ethylene/alpha-olefin copolymers; ethylene copolymers of propylene, higher olefins, carboxylic acids, or esters, and combinations thereof.

44. A pad according to claim 32, wherein said impact absorbing layer has a thickness about 4 inches or less.

45. A pad according to claim 32, wherein said impact absorbing layer is from about 1 to 3 inches thick.

46. A pad according to claim 32, wherein said impact absorbing layer has a density from about 1 to 9 pcf.

47. A pad according to claim 32, wherein said impact absorbing layer has a density from about 1.2 to 4 pcf.

48. A pad according to claim 32, wherein said impact absorbing layer has a density about 1.7 pcf.

49. A pad according to claim 32, wherein said high-density foam layer is a polyolefin.

50. A pad according to claim 49, wherein said high-density foam layer is comprised of a resin selected from the group consisting of low-density polyethylene (LDPE); linear low-density polyethylene (LLDPE); high-density polyethylene (HDPE); ethylene vinyl acetate (EVA); metallocene/single-site catalyzed copolymers of ethylene and one or more C₃ to C₁₀ alpha-olefin comonomers; heterogeneous Ziegler-Natta catalyzed ethylene/alpha-olefin copolymers; ethylene copolymers of propylene, higher olefins, carboxylic acids, or esters, and combinations thereof.

51. A pad according to claim 32, wherein said high-density foam layer has a thickness no greater than about 4 inches.

52. A pad according to claim 32, wherein said high-density foam layer has a thickness no greater than about 1/2 inch.

53. A pad according to claim 32, wherein said high-density foam layer has a density from about 1 to 9 pcf.

54. A pad according to claim 32, wherein said high-density foam layer has a density from about 4 to 8 pcf.

55. A pad according to claim 32, wherein said backing layer is selected from the groups consisting of polyolefins, including polyethylene, polypropylene, polystyrene, polyethylene terephthalate, acrylonitrile butadiene styrene, polyesters, polyurethane, and phenolics.

56. A pad according to claim 32, wherein said backing layer is a corrugated material.

57. A pad according to claim 32, wherein said backing layer is from about ⅛ to 2 inches thick.

58. A pad according to claim 32, wherein said backing layer is from about ⅛ to ¼ an inch thick.

59. A composite pad comprising:
an ionomer skin layer having an outer surface and an inner surface;
a high density foam layer attached to said inner surface, said high density foam having a density that is from about 4 to 8 pcf;
a backing layer; and
a low density foam layer sandwiched between said high density foam layer and said backing layer, said low density foam having a density that is from about 1 to 6 pcf.

60. A composite pad comprising:
a skin layer from about 15 to 35 mils thick having an outer surface and an inner surface, said skin layer is a film selected from the group consisting of ionomer, nylon, polyethylene (low and high-density), and polypropylene;
a high-density polyethylene foam layer attached to said inner surface, said high-density foam layer having a thickness that is no greater than about 1 inch and a density that is from about 4 to 8 pcf;
a corrugated backing layer having a top surface and a bottom surface, said backing layer having a thickness that is from about ⅛ to 1/4 inch thick; and
a low-density polyethylene foam layer sandwiched between said high-density foam layer and said backing layer, said low-density layer having a density about 1.7 pcf and a thickness from about 1 to 3 inches, and wherein said skin and high-density layer extend beyond the periphery of said backing layer and are folded around said backing layer and are attached to said bottom surface.

61. A horse trailer having interior walls that are lined with a composite pad that is in accordance with claim 60, wherein said bottom surface faces said interior walls.

62. A composite pad according to claim 61, wherein the abuse layer has a wear index that is from about 0.5 and below.
